(19) United States
(12) Patent Application Publication
(10) Pub. No.: US 2020/0307621 A1
(43) Pub. Date: Oct. 1, 2020

(54) VEHICLE REAL-TIME PERFORMANCE FEEDBACK SYSTEM

(71) Applicant: Ford Global Technologies, LLC, Dearborn, MI (US)

(72) Inventors: David Alfred OSTROWSKI, Northville, MI (US); Mark Anthony TASCILLO, Canton, MI (US); Smruti Ranjan PANIGRAHI, Farmington Hills, MI (US); Joseph NIEMIEC, Southgate, MI (US)

(21) Appl. No.: 16/954,241

(22) PCT Filed: Dec. 22, 2017
(86) PCT No.: PCT/US2017/068202

§ 371 Date: Jun. 16, 2020

(51) Int. Cl. B60W 50/14; G07C 5/00; G07C 5/08; B60K 35/00

(52) U.S. Cl. CPC B60W 50/14; G07C 5/008; B60W 2050/146; G07C 5/0808; B60K 35/00; G07C 5/0841

(57) ABSTRACT

A vehicle such as a hybrid electric vehicle (HEV) and method of operation, which include controller(s) coupled to a communication unit, configured to respond to a trip signal, and in response, to generate a driver notification to adjust vehicle performance parameters, such as acceleration, speed, braking, and others. The driver notification is generated to reduce fuel and/or battery consumption, and according to a recommendation signal that is received from and generated by a remote fleet server, and in response to instantaneous vehicle operating conditions that are communicated in real-time from the vehicle to the remote server. The recommendation signal includes a fuel and/or a battery consumption estimate, among other data. The vehicle controller is also responsive to detecting the one or more adjusted vehicle performance parameters, and to generate and store one or more estimate errors, which are respective differences between the estimates and actual fuel and battery consumption.

### TECHNICAL FIELD

The disclosure relates to estimating and recommending real-time fuel and battery economy and power consumption options, and generating feedback notifications alerts, which utilize remote server data analytics generated from real-time vehicle fuel and battery performance data and trip similarity data that is accumulated from the vehicle and from peer groups of vehicle fleets.

### BACKGROUND

In combustion engine, electric, and hybrid electric vehicles (all of which are herein collectively referred to as HEVs), fuel consumption and battery discharge is affected by driver behavior during operation, as well as by the ambient environment, vehicle performance, and other factors, all of which may introduce higher than desired fuel and battery power consumption, as well as errors in estimated fuel and battery performance. Such increased energy consumption and estimate errors have persisted despite some attempts to improve accuracy and to reduce fuel and battery power consumption.

### SUMMARY

Combustion engine, hybrid, plug-in hybrid, battery electric vehicles, and HEVs include fuel based combustion engines and/or high voltage traction battery or batteries, among other components and systems, which can experience less than optimal performance as a consequence of driver operational behaviors, environmental conditions, and inaccurate fuel and battery consumption estimates, among other issues. The disclosure is directed to improved systems and methods for generating driver behavior feedback notifications and for more accurately estimating battery and fuel consumption, using among other capabilities, a cloud-based, neural network analytical fuel economy and battery power consumption estimation and driver behavior recommendation technology. The new estimation and recommendation system receives and aggregates real-time driver behavior, and vehicle trip and performance data from a global fleet of such operating vehicles or HEVs.

The new and innovative system is configured to transmit real-time and instantaneous vehicle and trip data to one or more remote, cloud-based server(S) that ingest and digest this real-time data, and to discover and utilize otherwise unknown patterns in fuel and battery consumption as it is related to individual driver behavior and vehicle trip similarities, and those of a global fleet of vehicles. Such real-time data is categorized and analyzed according to peer groups and trip similarities, to discover and identify patterns of driver behaviors and vehicle performance across the global vehicle fleet. The discovered patterns are utilized to generate real-time feedback by way of driver notifications to individual vehicles, to adjust various vehicle performance parameters to reduce fuel and battery consumption.

The disclosure contemplates a real-time vehicle performance improvement system that utilizes real-time, aggregated “big data” describing actual fuel and/or battery performance and driver behavior, which is analyzed by a remote fleet server or servers, which is and/or which incorporates one or more and/or at least one cloud server-based, deep-learning neural network engine and/or engines that is/are trained to discover otherwise unrecognizable patterns from a global fleet of vehicles. The predictive and pattern recognition engine(s) of the remote fleet server(s) predict and/or estimate fuel and battery consumption, in response to instantaneous vehicle operating conditions received from each vehicle of the global fleet.

The remote fleet server(s) identify(ies) possible improvements that can reduce such fuel and battery consumption, and if possible, identifies adjustments that can be recommended and made to any individual vehicle regarding preferred or more desirable driver acceleration, coasting, speed, braking, and other vehicle performance parameters. If such adjustments are possible, they are transmitted to individual HEVs that are in communication with the remote server or servers.

In operation, HEVs in the global fleet of vehicles, transmit in real time to the remote server(s), vehicle location, environmental conditions, fuel and battery performance and consumption data, vehicle data, trip data, and other vehicle operating conditions and performance parameters. The remote fleet server(s) retain, aggregate, and analyze such data from the global vehicle fleet. The received and aggregated data is analyzed with a deep learning, neural network to discover otherwise hidden patterns within the received vehicle, trip, and related data, and categorizes such data and hidden patterns into categories that may include, for purposes of example, vehicle trip similarity and vehicle/driver peer group categories, among other possible groups.

The contemplated neural network of the remote server(s) is/are trained to predict various preferred vehicle operating conditions as a result of adjustments to the vehicle performance parameters, and to generate a recommendation signal that includes recommended adjustments to vehicle operating conditions and/or performance parameters, such that fuel and battery consumption can be improved and/or reduced. Each vehicle is identified to at least one such trip similarity and/or peer category and/or group, and is also compared to patterns identified in the categories and/or groups, to identify possible adjustments that can be made to one or more vehicle performance parameters, to change instantaneous vehicle operating conditions, which can improve and/or reduce fuel and/or battery consumption. The remote fleet server(s) also generate a peer match signal that identifies peer group information, and a trip similarity signal that identifies trip similarity group information.

In configurations and methods of operation of the disclosure, a combustion engine vehicle/HEV/PREY/BEV (collectively “HEV” herein for purposes of convenience without limitation) incorporates a controller that is, and/or controllers that are, coupled to a communication unit, which are configured to periodically monitor for and to respond to a trip signal, independent to and different from the trip similarity signal, generated by the HEV and its systems and subsystems. The trip signal indicates a vehicle key-on condition, and identifies initial operation of HEV. Periodic monitoring by the controller(s) may be configured to occur temporally, at discrete time intervals, and/or when certain vehicle performance parameters and/or instantaneous operating conditions change beyond various thresholds and/or threshold values.

The vehicle performance parameters and/or real-time or instantaneous operating conditions are monitored, captured, and communicated by the controller(s) via the communication unit to the remote fleet server(s). The server(s) receive, digest, ingest, and/or analyze the received vehicle information. In response, the server(s) generate and communicate the recommendation signal including the identified possible adjustments, among other data, and according to the generated trip similarity and peer match signals and related and other information.

The BEV controller(s) respond to the recommendation and other signals and information received from the remote fleet server(s), and generate one or more and/or at least one driver notification(s) that is/are communicated to one or more vehicle displays and/or mobile device displays, to adjust one or more and/or at least one vehicle performance parameters and/or operating conditions, such that battery and/or fuel consumption may be reduced. In one variation, the driver notification may communicate recommended adjustments to speed, coasting, acceleration, braking, and other vehicle parameters. The adjustments may further enable an autopilot or semi-autopilot system response, such as a cruise control adjustment, and in other arrangements may enable a driver to modify behavior, to adjust the parameters and operating conditions. In other variations, the driver notification and recommendations may include and/or enable adjustments to climate controls, cruise controls, lighting, infotainment, navigation, and other HEV systems, subsystems, components, and/or devices.

In other modifications according to the disclosure, the recommendation signal and/or other signals and information received from the remote server(s), include at least one of a fuel and a battery consumption estimate. The vehicle controller(s) in such modifications may be further configured to detect the one or more adjusted vehicle performance parameters, and to generate and store one or more estimate errors that are respective differences between the estimates and actual fuel and battery consumption. Such one or more and/or at least one estimate errors may be stored and/or communicated as part of or as an element of at least one of the operating conditions and vehicle performance parameters.

Variations of the REV controller(s) also contemplate further configurations that, at discrete time intervals, readjust the driver notification(s), according to updated recommendation signals and/or other signals and information, received by the communication unit from the remote fleet server(s). Such updated notification(s) in these variations also include at least one and/or one or more of an updated fuel and/or battery consumption estimate(s). These updates are generated and communicated by the remote fleet server(s) in response to one or more new real-time and/or instantaneous operating condition(s) received from the REV, which include(s) the HEV controller-generated estimate errors communicated by the HEV communication unit(s) to the remote server(s).

Further arrangements of the disclosure also include the communication unit or units of the HEV configured to communicate with the remote fleet server, by an authenticated connection to a mobile device that is located within, near, and/or proximate to a cabin of the vehicle, and which is coupled to and in communication with the HEV communication unit. In other adaptations, the HEV communication unit may be augmented and/or replaced by the mobile device as the HEV communication unit. In these variations too, the controller(s) are configured to generate the driver notification, according to the recommendation signal that includes one or more recommendations to adjust at least one of braking, coasting, speed, acceleration, and other vehicle performance parameters and operating conditions.

In each of such arrangements, the controller(s) also communicate(s) the generated driver notification(s) to at least one and/or one or more of the mobile device and vehicle displays. The generated and displayed driver notification(s) in other variations also include one or more and/or at least one of an actual and estimated fuel and battery consumption, such miles or kilometer per gallon of fuel and/or miles or kilometers per kilowatt of battery power, and other data and information.

The disclosure also contemplates additional modifications that include the controller(s) configured to generate the instantaneous vehicle operating conditions to include vehicle data and trip data. Such vehicle data includes, in some variations, one or more of make and model information, vehicle identification number, and onboard diagnostic codes and related information and data. In further arrangements, such generated trip data includes at least one of and/or one or more of estimated trip length or distance, frequency, and/or time or duration, and other related information.

In these adaptations, the remote fleet server(s) generate the peer match signal according to such vehicle data, and the trip similarity signal according to the trip data, and the recommendation signal according to the peer match and similarity signals, and other parameters, conditions, and data received from HEV and other vehicles in the global vehicle fleet. The disclosure is also directed to variations of the controller(s) configured to additionally generate the instantaneous operating conditions to also include vehicle environment and location data, which incorporates geographic location, ambient temperature, humidity, and atmospheric pressure, as well as other similar information and data.

This summary of the implementations and configurations of the HEVs and described components and systems introduces a selection of exemplary implementations, configurations, and arrangements, in a simplified and less technically detailed arrangement, and such are further described in more detail below in the detailed description in connection with the accompanying illustrations and drawings, and the claims that follow.

This summary is not intended to identify key features or essential features of the claimed technology, nor is it intended to be used as an aid in determining the scope of the claimed subject matter. The features, functions, capabilities, and advantages discussed here may be achieved independently in various example implementations or may be combined in yet other example implementations, as further described elsewhere herein, and which may also be understood by those skilled and knowledgeable in the relevant fields of technology, with reference to the following description and drawings.

### BRIEF DESCRIPTION OF THE DRAWINGS

FIG. 1 is an illustration of a combustion engine and hybrid electric vehicle and its systems, components, sensors, actuators, and methods of operation; and

FIG. 2 illustrates certain aspects of the disclosure depicted in FIG. 1, with components removed and rearranged for purposes of illustration.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As those of ordinary skill in the art should understand, various features, components, and processes illustrated and described with reference to any one of the figures may be combined with features, components, and processes illustrated in one or more other figures to enable embodiments that should be apparent to those skilled in the art, but which may not be explicitly illustrated or described. The combinations of features illustrated are representative embodiments for typical applications. Various combinations and modifications of the features consistent with the teachings of this disclosure, however, could be desired for particular applications or implementations, and should be readily within the knowledge, skill, and ability of those working in the relevant fields of technology.

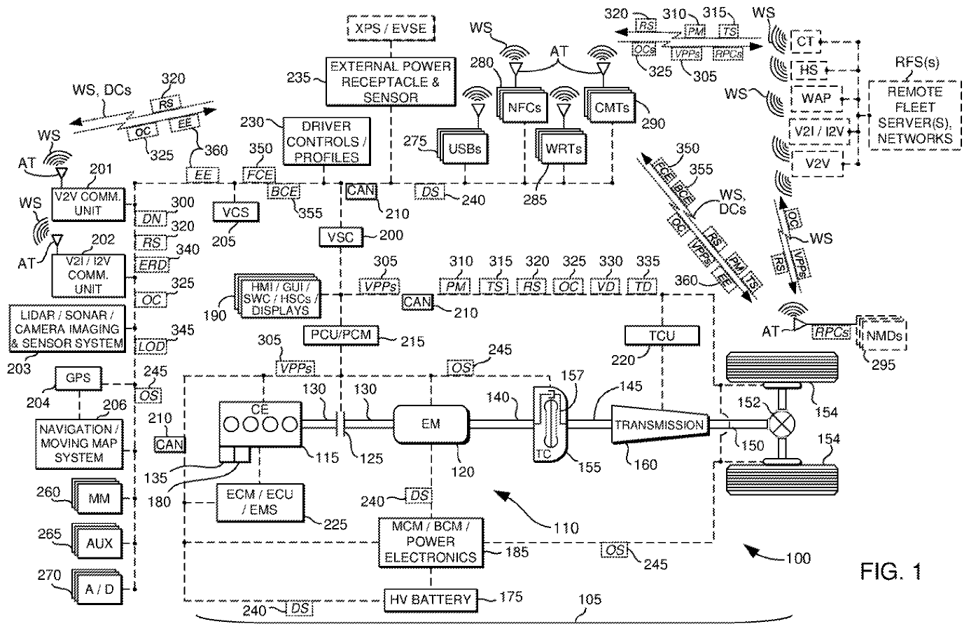

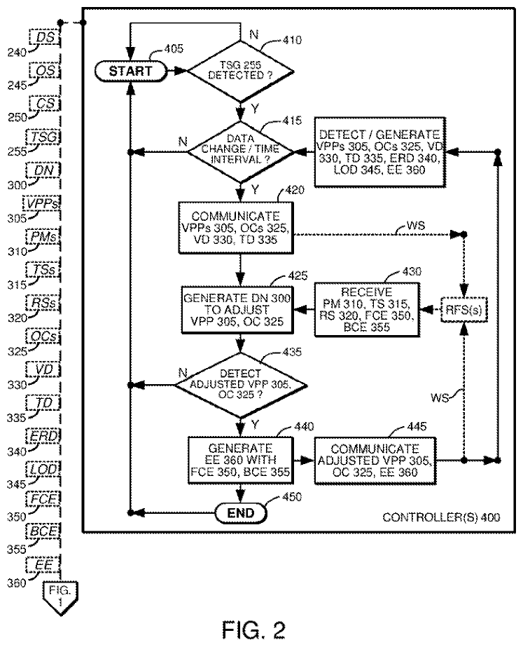

With reference now to the various figures and illustrations and to FIGS. 1 and 2, and specifically to FIG. 1, a schematic diagram of a combustion engine and/or hybrid electric vehicle (HEV) 100 is shown, and illustrates representative relationships among components of HEV 100, which can also be a battery electric vehicle (BEV), a plug-in hybrid electric vehicle (PHEV), and combinations and modifications thereof, which are herein collectively referred to as an “HEV”. Physical placement and orientation of the components within vehicle 100 may vary.

Vehicle 100 includes a driveline 105 that has a powertrain 110, which includes a combustion engine (CE) 115 and/or an electric machine or electric motor/generator/starter (EM) 120, which generate power and torque to propel vehicle 100. Engine or CE 115 is a gasoline, diesel, biofuel, natural gas, or alternative fuel powered combustion engine, which generates an output torque in addition to other forms of electrical, cooling, heating, vacuum, pressure, and hydraulic power by way of front end engine accessory devices (FEADs) described elsewhere herein. CE 115 is coupled to electric machine or EM 120 with a disconnect clutch 125. CE 115 generates such power and associated engine output torque for transmission to EM 120 when disconnect clutch 125 is at least partially engaged.

EM 120 may be any one of a plurality of types of electric machines, and for example may be a permanent magnet synchronous motor, electrical power generator, and engine starter 120. For example, when disconnect clutch 125 is at least partially engaged, power and torque may be transmitted from engine 115 to EM 120 to enable operation as an electric generator, and to other components of vehicle 100. Similarly, EM 120 may operate as a starter for engine 115 with disconnect clutch 125 partially or fully engaged to transmit power and torque via disconnect clutch drive shafts 130 to engine 115 to start engine 115, in vehicles that include or do not include an independent engine starter 135.

Further, EM or electric machine 120 may assist engine 115 in a “hybrid electric mode” or an “electric assist mode” by transmitting additional power and torque to turn drive shafts 130 and 140. Also, EM 120 may operate in an electric only mode wherein engine 115 is decoupled by disconnect clutch 125 and which may be shut down, enabling EM 120 to transmit positive or negative (reverse) mechanical torque to EM drive shaft 140 in forward and reverse directions. When in a generator mode, EM 120 may also be commanded to produce negative electrical torque (when being driven by CE 115 and/or other drivetrain elements) and to thereby generate electricity for charging batteries and powering vehicle electrical systems, and while CE 115 is generating propulsion power for vehicle 100. EM 120 and/or other electric motor generators also may enable regenerative braking when in generator mode by converting rotational, kinetic energy from powertrain 110 and/or wheels 154 during deceleration, into negative electrical torque, and into regenerated electrical energy for storage, in one or more batteries 175, 180, as described in more detail below.

Disconnect clutch 125 may be disengaged to enable engine 115 to stop or to run independently for powering engine accessories, while EM 120 generates drive power and torque to propel vehicle 100 via EM drive shaft 140, torque convertor drive shaft 145, and transmission output drive shaft 150. In other arrangements, both engine 115 and EM 120 may operate with disconnect clutch 125 fully or partially engaged to cooperatively propel vehicle 100 through drive shafts 130, 140, 150, differential 152, and wheels 154. Each or any such components may also be combined in part and/or entirely in a comparable transaxle configuration (not shown). Driveline 105 may be further modified to enable regenerative braking from one or any or all wheel(s) 154, using a selectable and/or controllable differential torque capability. Although FIG. 1 schematically depicts two wheels 154, the disclosure contemplates driveline 105 to include additional wheels 154.

The schematic of FIG. 1 also contemplates alternative configurations with more than one engine 115 and/or EM 120, which may be offset from drive shafts 130, 140, and where one or more of engines 115 and EMs 120 are positioned in series and/or in parallel elsewhere in driveline 105, such as between or as part of a torque convertor and a transmission, and/or a transaxle, off-axis from the drive shafts, and/or elsewhere and in other arrangements. Still other variations are contemplated without deviating from the scope of the present disclosure. Driveline 105 and powertrain 110 also include a transmission that includes a torque convertor (TC) 155, which couples engine 115 and EM 120 of powertrain 110 with and/or to a transmission 160. TC 155 may further incorporate a bypass clutch and clutch lock 157 that may also operate as a launch clutch, to enable further control and conditioning of the power and torque transmitted from powertrain 110 to other components of vehicle 100.

Powertrain 110 and/or driveline 105 further include one or more batteries 175, 180. One or more such batteries can be a higher voltage, direct current battery or batteries 175 operating in ranges between about 48 to 600 volts, and sometimes between about 140 and 300 volts or more or less, which is/are used to store and supply power for EM 120 and during regenerative braking for capturing and storing energy, and for powering and storing energy from other vehicle components and accessories. Other batteries can be a low voltage, direct current battery(ies) 180 operating in the range of between about 6 and 24 volts or more or less, which is/are used to store and supply power for starter 135 to start engine 115, and for other vehicle components and accessories.

Batteries 175, 180 are respectively coupled to engine 115, EM 120, and vehicle 100, as depicted in FIG. 1, through various mechanical and electrical interfaces and vehicle controllers, as described elsewhere herein. High voltage EM battery 175 is also coupled to EM 120 by one or more of a motor control module (MCM), a battery control module (BCM), and/or power electronics 185, which are configured to convert and condition direct current (DC) power provided by high voltage (HV) battery 175 for EM 120.

MCM/BCM/power electronics 185 are also configured to condition, invert, and transform DC battery power into three phase alternating current (AC) as is typically required to power electric machine or EM 120. MCM/BCM 185/power electronics is also configured to charge one or more batteries 175, 180 with energy generated by EM 120 and/or front end accessory drive components, and to receive, store, and supply power from and to other vehicle components as needed. Such controllers, including for example, those incorporated with power electronics 185 are configured to monitor battery sensors to detect voltage, current, state-of-charge (SoC), charge the battery(ies), to adjust and control a charge-rate and charge-time therefor, to monitor and estimate fuel economy, to monitor recharging, and to discharge and deliver power from the battery(ies), among other capabilities.

With continued reference to FIG. 1, vehicle 100 further includes one or more controllers and computing modules and systems, in addition to MCM/BCM/power electronics 185, which enable a variety of vehicle capabilities. For example, vehicle 100 may incorporate a vehicle system controller (VSC) 200 and a vehicle computing system (VCS) and controller 205, which are in communication with MCM/BCM 185, and other controllers, and a vehicle network such as a controller area network (CAN) 210, and a larger vehicle control system and other vehicle networks that include other micro-processor-based controllers as described elsewhere herein. CAN 210 may also include network controllers in addition to communications links between controllers, sensors, actuators, and vehicle systems and components, as is illustrated schematically in the figures, for purposes of example without limitation, as dotted and/or dashed lines, and with similar schematic and graphical representations.

Such CANs 210 are known to those skilled in the technology and are described in more detail by various industry standards, which include for example, among others, Society of Automotive Engineers International™ (SAE) J1939, entitled “Serial Control and Communications Heavy Duty Vehicle Network”, and available from standards.sae.org, as well as, car informatics standards available from International Standards Organization (ISO) 11898, entitled “Road vehicles—Controller area network (CAN),” and ISO 11519, entitled “Road vehicles—Low-speed serial data communication,”, available from www.iso.org/ics/43.040.15/x/.

With continued reference to FIG. 1, vehicle 100 further includes one or more controllers and computing modules and systems, in addition to the controller(s) already described, which enable a variety of vehicle capabilities. For example, in some configurations for purposes of example but not limitation, VSC 200 and/or VCS 205 is/are and/or incorporates the SYNC™, APPLINK™, MyFord Touch™ and/or open source SmartDeviceLink and/or OpenXC onboard and offboard vehicle computing systems, in-vehicle connectivity, infotainment, and communications system and application programming interfaces (APIs), for communication and control of and/or with offboard and/or external devices, systems, and components.

For further examples, but not for purposes of limitation, at least one of and/or one or more of the controller(s) such as VSC 200 and VCS 205, may incorporate and further be and/or include one or more accessory protocol interface modules (APIMs) and/or an integral or separate head unit, which may be, include, and/or incorporate an information and entertainment system (also referred to as an infotainment system and/or an audio/visual control module or ACM/AVCM). Such modules include and/or may include a multimedia devices such as a media player (MP3, Blu-Ray™, DVD, CD, cassette tape, etc.), stereo, FM/AM/satellite radio receiver, and the like, as well as a human machine interface (HMI) 190, graphical user interface (GUI) 190, and/or display unit(s) 190 as described elsewhere herein.

Such contemplated components and systems are available from various sources, and are for purposes of example manufactured by and/or available from the SmartDeviceLink Consortium, the OpenXC project, the Ford Motor Company, and others. See, for example, SmartDeviceLink.com, openXCplatform.com, www.ford.com, U.S. Pat. Nos. 9,080,668, 9,042,824, 9,092,309, 9,141,583, 9,141,583, 9,680,934, and others.

In further examples, SmartLinkDevice (SDL), OpenXC, and SYNC™ AppLink™ are each illustrative exemplars that enable at least one of and/or one or more of the controller(s) such as VSC 200 and VCS 205, to communicate remote procedure calls (RPCs) utilizing embedded application programming interfaces (APIs) that enable command and control of internal and external or onboard and offboard devices, mobile devices, and applications, by utilizing in-vehicle or onboard HMIs, GUIs, and other input and output devices 190. Such further include onboard vehicle instrument cluster hardware and software controls (HSCs), buttons, and/or switches, as well as steering wheel controls and buttons (SWCs), instrument cluster and panel hardware and software buttons and switches 190, among other controls, also depicted in the figures schematically and collectively with reference numeral 190 (FIG. 1). Exemplary systems such as SDL, OpenXC, and/or AppLink™ enable functionality of the mobile device to be available and enabled utilizing the HMI of vehicle 100 such as HSCs, SWCs, HMIs, and GUIs 190.

VCS 205 and/or other controller(s) may include, be configured with, and/or cooperate with one or more communications, navigation, and other systems, units, controllers, and/or sensors, such as a vehicle to vehicle communications system (V2V) 201, and roadway and cloud-based network infrastructure to vehicle and vehicle to infrastructure communication system (I2V, V2I) 202, a LIDAR/SONAR (light and/or sound detection and ranging) and/or video camera roadway proximity imaging and obstacle sensor system 203, a GPS or global positioning system 204, and a navigation and moving map display and sensor system 206.

Such communications systems, units, controllers, may be configured with, as, and be part of other communications units and enable bidirectional communications by wired and wireless communications that may include cellular, wireless ethernet and access points such as WiFi™ wireless capabilities, near field communications such as Bluetooth™, and many others. The VCS 205 can cooperate in parallel, in series, and distributively with VSC 200 and other controllers to manage and control REV 100 and such other controllers, and/or actuators, in response to sensor and communication signals, data, parameters, and other information identified, established by, communicated to, and received from these vehicle systems, controllers, and components, as well as other systems external and/or remote to HEV 100.

While illustrated here for purposes of example, as discrete, individual controllers, MCM/BCM 185, VSC 200, and VCS 205 may control, be controlled by, communicate signals to and from, and exchange data with other controllers, and other sensors, actuators, signals, and components that are part of the larger vehicle and control systems, external control systems, and internal and external networks. The capabilities and configurations described in connection with any specific micro-processor-based controller as contemplated herein may also be embodied in one or more other controllers and distributed across more than one controller such that multiple controllers can individually, collaboratively, in combination, and cooperatively enable any such capability and configuration. Accordingly, recitation of “a controller” or “the controller(s)” is intended to refer to such controllers both in the singular and plural connotations, and individually, collectively, and in various suitable cooperative and distributed combinations.

Further, communications over the network and CAN 210 are intended to include responding to, sharing, transmitting, and receiving of commands, signals, data, embedding data in signals, control logic, and information between controllers, and sensors, actuators, controls, and vehicle systems and components. The controllers communicate with one or more controller-based input/output (I/O) interfaces that may be implemented as single integrated interfaces enabling communication of raw data and signals, and/or signal conditioning, processing, and/or conversion, short-circuit protection, circuit isolation, and similar capabilities. Alternatively, one or more dedicated hardware or firmware devices, controllers, and systems on a chip may be used to precondition and preprocess particular signals during communications, and before and after such are communicated.

In further illustrations, MCM/BCM 185, VSC 200, VCS 205, CAN 210, and other controllers, may include one or more microprocessors or central processing units (CPU) in communication with various types of computer readable storage devices or media. Computer readable storage devices or media may include volatile and nonvolatile storage in read-only memory (ROM), random-access memory (RAM), and non-volatile or keep-alive memory (NVRAM or KAM). NVRAM or KAM is a persistent or non-volatile memory that may be used to store various commands, executable control logic and instructions and code, data, constants, parameters, and variables needed for operating the vehicle and systems, while the vehicle and systems and the controllers and CPUs are unpowered or powered off. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing and communicating data.

With attention invited again to FIG. 1, HEV 100 also may include a powertrain control unit/module (PCU/PCM) 215 coupled to VSC 200 or another controller, and coupled to CAN 210 and engine 115, EM 120, and TC 155 to control each powertrain component. A transmission control unit (TCU) 220 is also coupled to VSC 200 and other controllers via CAN 210, and is coupled to transmission 160 and also optionally to TC 155, to enable operational control. An engine control module (ECM) or unit (ECU) or energy management system (EMS) 225 may also be included having respectively integrated controllers and be in communication with CAN 210, and is coupled to engine 115 and VSC 200 in cooperation with PCU 215 and TCU 220 and other controllers.

In this arrangement, VSC 200 and VCS 205 cooperatively manage and control the vehicle components and other controllers, sensors, and actuators, including for example without limitation, PCU 215, TCU 220, MCM/BCM 185, and/or ECU/EMS 225, among various others. For example, the controllers may communicate control commands, logic, and instructions and code, data, information, and signals to and/or from engine 115, disconnect clutch 125, EM 120, TC 155, transmission 160, batteries 175, 180, and MCM/BCM/power electronics 185, and other components and systems.

The controllers also may control and communicate with other vehicle components known to those skilled in the art, even though not shown in the figures. The embodiments of vehicle 100 in FIG. 1 also depict exemplary sensors and actuators in communication with vehicle network and CAN 210 that can transmit and receive signals to and from VSC 200, VCS 205, and other controllers. Such control commands, logic, and instructions and code, data, information, signals, settings, and parameters, including driver preferred settings and preferences, may be captured and stored in, and retrieved and communicated from a repository of driver controls and profiles 230.

For further example, various other vehicle functions, actuators, and components may be controlled by the controllers within and in cooperation with HEV 100 systems and components, and may receive signals from other controllers, sensors, and actuators, which may include, for purposes of illustration but not limitation, front-end accessory drive (FEAD) components and various sensors for battery charging or discharging, including sensors for detecting and/or determining the maximum charge, charge-state or state-of-charge (SoC), voltage and current, battery chemistry and life-cycle parameters, and discharge power limits, external environment ambient air temperature (TMP), pressure, humidity, and component temperatures, voltages, currents, and battery discharge power and rate limits, and other components. Such sensors are configured to communicate with the controllers and CAN 210 and may, for further example, establish or indicate ignition switch position (IGN) and a key-on or key-off condition, external environment temperature and pressure, engine and thermal management system sensors, charge receptacle sensors, and external power source voltage, current, and related data communications sensors, among others.

HEV 100 also includes at least one external power source receptacle and sensor 235, which is coupled with the various controllers, including for example BCM/MCM/power electronics 185 and HV battery 175. Receptacle 235 is utilized when HEV 100 is stationary and parked adjacent to an external power source (XPS), such as in a home, office, or other electrical power charging station or location, which stations are also known to those knowledgeable in the technology as electric vehicle supply equipment (EVSE). These controllers are configured to detect the presence of XPS when it is connected to receptacle 235, and to initiate a charging/recharging cycle or event of HV battery 175, battery 180, as well as enabling power to be supplied to HEV 100 for various purposes.

Such controllers may also enable bidirectional communication between HEV 100 and external XPS/EVSE to establish power capacity, cost of power, power use authorization, compatibility, and other parameters and information about and from the external XPS. Such communications between HEV 100 and external XPS may enable automated charging, purchase of power, and may enable communication between external XPS and VSC 200 and VCS 205, as well as communication with remote systems external to HEV 100 and its various controllers. Additionally, HEV 100 may autonomously interact with both external XPS and one or more of VSC 200 and VCS 205 to communicate information to enable automated charging of HEV 100, and estimating of fuel economy, and communications of various vehicle and systems data and parameters to such external systems.

To enable charging of the HV battery(ies) 175 and/or other batteries, one or more of the controllers, such as those included with BCM/MCM/power electronics 185 are configured to detect external XPS being connected to receptacle 235, and to generate and communicate an external-power signal or direct-current charge-signal (DS) 240, which may include earlier described information indicating connection to XPS, power available from XPS, cost of such power, compatibility data, and use-authorization and authentication data, and related information. In response, the power electronics 185 and/or other controllers initiate charging at a charge-rate of the battery(ies) 175, 180 or others. Additionally, the various controller(s) may also generate DS 240 in response to depletion of batteries 175, 180, or others, such that BCM/MCM/power electronics 185 may initiate charging via ICE 115 and EM 120, and other charging capabilities.

As described and illustrated in the various figures, including FIGS. 1 and 2, the signals and data, including for example, external-power signal DS 240, and related control logic and executable instructions and other signals, and data can also include other signals (OS) 245, and control or command signals (CS) 250 received from and sent to and between controllers and vehicle components and systems. The external-power signal DS 240, OS 245, and CS 250, and other signals, related control logic and executable instructions, parameters, and data can and/or may be predicted, generated, established, received, communicated, to, from, and between any of the vehicle controllers, sensors, actuators, components, and internal, externals, and remote systems.

Any and/or all of these signals can be raw analog or digital signals and data, or preconditioned, preprocessed, combination, and/or derivative data and signals generated in response to other signals, and may encode, embed, represent, and be represented by voltages, currents, capacitances, inductances, impedances, and digital data representations thereof, as well as digital information that encodes, embeds, and/or otherwise represents such signals, data, and analog, digital, and multimedia information.

The communication and operation of the described signals, commands, control instructions and logic, and data and information by the various contemplated controllers, sensors, actuators, and other vehicle components, may be represented schematically as shown in FIGS. 1 and 2, and by flow charts or similar diagrams as exemplified in the methods of the disclosure illustrated specifically in FIG. 2. Such flow charts and diagrams illustrate exemplary commands and control processes, control logic and instructions, and operation strategies, which may be implemented using one or more computing, communication, and processing techniques that can include real-time, event-driven, interrupt-driven, multi-tasking, multi-threading, and combinations thereof.

The steps and functions shown may be executed, communicated, and performed in the sequence depicted, and in parallel, in repetition, in modified sequences, and in some cases may be combined with other processes and/or omitted. The commands, control logic, and instructions may be executed in one or more of the described microprocessor-based controllers, in external controllers and systems, and may be embodied as primarily hardware, software, virtualized hardware, firmware, virtualized hardware/software/firmware, and combinations thereof.

With continuing reference to the various figures, including FIG. 1 the disclosure contemplates HEV 100 including at least one and/or one or more of the controller(s) coupled to the battery(ies) 175, 180, which controller(s) may be any of VSC 200, VCS 205, PCU 215, TCU 220, MCM/BCM 185, and/or ECU/EMS 225, and a communication unit or units, such as VSC 200, V2V 201, I2V/V2I 202, and/or communications units incorporated with VCS 205. At least one, one or more, and/or any of such controllers are also configured to generate and communicate a trip signal TSG 255, which identifies or indicates a vehicle key-on condition, upon start-up and initial operation of HEV 100. One or more of these controller(s) are coupled to at least one and/or one or more of the vehicle onboard communications units 200, 201 202, 205, and others.

HEV 100 may also further include, incorporate, be paired to, synchronized with, and/or be coupled with, as such communication units and/or as components and/or subsystems thereof, one or more and/or at least one vehicle-based and onboard multimedia devices 260 (MM), auxiliary input(s) 265 (AUX), and analog/digital (A/D) circuits 270, universal serial bus port(s) (USBs) 275, near field communication transceivers (NFCs) 280, wireless routers and/or transceivers (WRTs) 285, such as Bluetooth™ devices, that enable wireless personal and local area networks (WPANs, WLANs) or “WiFi” IEEE 802.11 and 803.11 communications standards.

The controller(s) and devices(s) of vehicle 100 are also coupled with, incorporate, and/or include onboard and/or offboard analog and digital cellular network modems and transceivers (CMTs) 290 utilizing voice/audio and data encoding and technologies that include for example, those managed by the International Telecommunications Union (ITU) as International Mobile Telecommunications (IMT) standards, which are often referred to as global system for mobile communications (GSM), enhanced data rates for GSM evolution (EDGE), universal mobile telecommunications system (UMTS), 2G, 3G, 4G, 5G, long-term evolution (LTE), code, space, frequency, polarization, and/or time division multiple access encoding (CDMA, SDMA, FDMA, PDMA, TDMA), and similar and related protocols, encodings, technologies, networks, and services.

Such contemplated onboard and offboard devices and components, among others, are configured to enable bidirectional wired and wireless communications between components and systems of vehicle 100, CAN 210, and other external devices and systems and PANs, LANs, and WANs. A/D circuit(s) 270 is/are configured to enable analog-to-digital and digital-to-analog signal conversions. Auxiliary inputs 265 and USBs 275, among other devices and components, may also enable in some configurations wired and wireless Ethernet, onboard diagnostic (OBD, OBD II), free-space optical communication such as Infrared (IR) Data Association (IrDA) and non-standardized consumer IR data communication protocols, IEEE 1394 (FireWire™ (Apple Corp.), LINK™ (Sony), Lynx™ (Texas Instruments)), EIA (Electronics Industry Association) serial protocols, IEEE 1284 (Centronics Port protocols), S/PDIF (Sony/Philips Digital Interconnect Format), and USB-IF (USB Implementers Forum), and similar data protocols, signaling, and communications capabilities

Auxiliary inputs 265 and A/D circuits 270, USBs 275, NFCs 280, WRTs 285, and/or CMTs 290, is/are coupled with, integrated with, and/or may incorporate integral amplifier, signal conversion, and/or signal modulation circuits, which are configured to attenuate, convert, amplify, and/or communicate signals, and which are further configured to receive various analog and/or digital input signals, data, and/or information that is processed and adjusted and communicated to and between the various wired and wireless networks and controllers.

Such wired and wireless contemplated networks and controllers include, for example but not limitation, CAN 210, VSC 200, VCS 205, and other controllers and networks of vehicle 100. Auxiliary inputs 265, A/D circuits 270, USBs 275, NFCs 280, WRTs 285, and/or CMTs 290, and related hardware, software, and/or circuitry are compatible and configured to receive, transmit, and/or communicate at least one of and/or one or more of a variety of wired and wireless signals, signaling, data communications, and/or data streams (WS), and data such as navigation, audio and/or visual, and/or multimedia signals, commands, control logic, instructions, information, software, programming, and similar and related data and forms of information.

Additionally, one or more input and output data communication, audio, and/or visual devices 190, are contemplated to be integrated with, coupled to, and/or connectable to, auxiliary inputs 265, A/D circuits 270, USBs 275, NFCs 280, WRTs 285, and/or CMTs 290, as well as to the other contemplated controller(s) and wired and wireless networks internal to vehicle 100, and in some circumstances external to and offboard vehicle 100. For example, the one or more input and output devices include additional display(s) 190, and nomadic and mobile devices (NMDs) 295, among others, which each include at least one and/or one or more integrated signaling and communications antennas and/or transceivers (AT).

Such input and output devices 190 are and/or may be selectable, connectable, synchronized with, paired to, and/or actuatable with an input selector that may be any of HSCs 190, and may also include, incorporate, and/or be integrated with and/or as part of GUI 190 and the contemplated hardware and software HSCs, SWCs, controls, buttons, and/or switches 190. Such HSCs 190, as already noted, may be hardware or software or combinations thereof and may be configurable utilizing one or more predetermined, default, and adjustable factory and/or driver controls, profiles, and/or preferences of repository 230.

The contemplated additional display(s) 190, NMDs 295, and/or other portable auxiliary devices, may further include for example but not limitation, cell phones, mobile phones, smart phones, satellite phones and modems and communications devices, tablets, personal digital assistants, personal media players, key fob security and data storage devices, personal health devices, laptops, portable wireless cameras, headsets and headphones that may include microphones, wired and wireless microphones, portable NFC and Bluetooth compatible speakers and stereo devices and players, portable GPS and GNSS devices, and similar devices and components that each may include integrated transceivers and antennas AT, wired, wireless, and plugged data connectors and data connections (DCs), and related components, for wired and wireless multimedia and data communications signals WS.

Such contemplated input, output, and/or communications devices, components, subsystems, and systems onboard vehicle 100 are and/or may be configured to bidirectionally communicate over wired and wireless data connections DCs and wired and wireless signals and signaling and data communications and data streams WS, with external near and far nomadic, portable, and/or mobile devices 295, networks, and external communications systems (V2X) that may include, for example, roadway and infrastructure communications systems (V2I/I2V) 202, such as hotspots and wireless access points (HS/WAPs, FIG. 1), nano and micro and regular cellular access points and towers (CT, FIG. 1), and related and accessible external, remote networks, systems, and servers.

With continuing reference to the various figures, including FIGS. 1 and 2, it may be understood by those with knowledge in the relevant fields of technology that the disclosure contemplates vehicle and/or HEV 100 to include at least one and/or one or more controller(s) such as VSC 200, VCS 205, and others coupled with one or more an in-vehicle or onboard transceiver AT, such as those described in connection with USBs 275, NFCs 280, WRTs 285, and/or CMTs 290. The controller(s) 200, 205, and others, and transceiver(s) AT, are configured to detect WSs and connect to nearby or proximate or far wired and wireless network devices having in-range WSs, as well as third-party, offboard, external devices such as nomadic, portable, and/or mobile or nomadic mobile devices 295.

The one or more controller(s) VSC 200, VCS 205, and others, are configured to generate the various OS 245, CS 250, and other signals to include and/or cause generation of one or more driver notification signals and/or notifications DNs 300, in response to other signals and information as described elsewhere herein. Such DNs 300 can in variations include one or more of text, audio, and multimedia data and information. DNs 300 are communicated internally and onboard vehicle and HEV 100 and externally to offboard devices and components with one or more of in-vehicle or onboard transceiver(s) AT, coupled with USBs 275, NFCs 280, WRTs 285, CMTs 290, NMDs 295, V2V 201, V2I/I2V 202, and/or other communication units, via one or more signaling paths WSs.

At least one of the controller(s) VSC 200, VCS 205, and others, are also configured to detect, capture, generate, adjust, and/or communicate various vehicle and systems and subsystems data, information, vehicle trip and travel data, and performance parameters VPPs 305, which are also communicated within and externally to vehicle and HEV 100 via the various communication units and signaling paths. Such VPPs 305 can include, for purposes of illustration and example, but not for purposes of limitation, vehicle speed, coasting, acceleration, braking, actual fuel remaining and consumption and capacity, actual battery power capacity and power remaining and consumption, and settings and preferences for cruise control, climate controls, interior and external vehicle lighting, infotainment system, navigation system, and other HEV systems, subsystems, components, and/or devices. Such actual fuel and battery consumption may be identified utilizing one or more common units of measure, and may include for example, such miles/kilometers per gallon of fuel and/or miles/kilometers per kilowatt of battery power, among others.

As also described elsewhere herein, the controller(s) of vehicle or HEV 100 are modified to automatically adjust or enable manual adjustment of VPPs 305 according to at least one of peer match PM signal 310, trip similarity signal TS 315, and recommendation signal RS 320, which are received via the communications units from and generated by at least one and/or one or more remote fleet server(s) RFSs (FIGS. 1, 2). The one or more RFSs generate and communicate PM 310, TS 315, and/or RS 320 in response to instantaneous and/or real-time vehicle operating conditions OCs 325, communicated to RFSs by at least one of the communications units V2V 201, V2I 202, USBs 275, NFCs 280, WRTs 285, CMTs 290, NMDs 295, and/or communications units that may be incorporated with VSC 200 and/or VCS 205, among others.

Each RFS is configured to receive, digest, ingest, and/or analyze the received vehicle information, such as VPPs 305 and OCs 325, and/or other vehicle data. In response, RFS(s) generate and communicate RS 320, according to the generated PMs 310, TSs 315, and other information. One or more of the RFS-generated PMs 310, TSs 315, RSs 320, include in variations of the disclosure, possible adjustments to VPPs 305 and/or OCs 325, among other data, which are identified by RFS(s) and communicated to the vehicle controller(s) to enable generation of DNs 300.

The disclosure also includes adaptations of the controller(s) VSC 200, VCS 205, and others, configured to generate the instantaneous and/or real-time OCs 325, which incorporate, represent, and/or include one or more of current and/or historical vehicle data VD 330, trip data TD 335, and/or other vehicle data and information. VD 330 includes, for purposes of example without limitation, at least one of and/or one or more of vehicle make and model information, vehicle identification number (VIN), onboard diagnostic codes (OBD, OBD II, PIDs), electrical power and vehicle cooling demands, vehicle power availability and demands, cabin climate control profile, and driver speed, coasting, acceleration, and braking behavior, and/or other vehicle data.

In other variations, current and/or historical environment data and roadway traffic and condition data ERD 340 from controllers that may include VSC 200, VCS 205, and communication units that may include V2V 201, I2V/V2I 202, and/or NMDs 295. ERD 340 includes, for example without limitation, ambient temperature, precipitation, humidity, atmospheric pressure, and related roadway and traffic conditions, among other information. Current and/or historical vehicle geographic location data LOD 345 may also be generated by the vehicle controller(s) and obtained from in-vehicle and onboard as well as external offboard GPS devices including vehicle GPS 204 and navigation system 206, and/or NMDs 295, among other controllers and components.

In further arrangements, such generated TD 335 includes at least one of and/or one or more of estimated and/or predicted trip length or distance, trip start location, predicted or planned or actual trip stop location, frequency of trips having and/or similar to current trip parameters, and/or trip time or duration, and other related trip information. VD 330 and/or TD 335 can also further incorporate, include, and/or be generated according to and/or from ERD 340, LOD 345, among other vehicle and trip information and data.

In adaptations of the disclosure, RFS(s) generate PMs 310 according to VD 330 received from vehicle or HEV 100, and TSs 315 according to TD 335, and RSs 320 according PMs 310, TSs 315, and other parameters, conditions, and data received from REV 100 and other vehicles in the global vehicle fleet. The RFS(s) utilize aggregated data and parameters, such as VD 330 and TD 335, received by the internet and/or cloud-based RFS from vehicle or HEV 100 as well as other vehicles in the global fleet of similar and/or identical vehicles or HEVs 100. As also described elsewhere herein, RFS(s) include(es) remote big-data analytics engines and computational resources, which may utilize neural network, artificial intelligence, and other analytical technologies to discover otherwise unrecognizable patterns in the received, collected, aggregated, and analyzed VD 330 and TD 335, to enable peer matching and trip similarity scoring upon demand and in real-time, such that DNs 300 with recommendations can be generated by RFS(s) and communicated to operating vehicles or HEVs 100.

For further examples, RFS(s) may accomplish such peer matching and generating PMs 310 by grouping VD 330 received from various vehicles or HEVs 100 of the global fleet of vehicles, according to one or more of vehicle make and model information, VINs, OBDs, PIDs, electrical power and vehicle cooling demands, fuel consumption in kilometers/miles per gallon of fuel, vehicle power availability and demands, battery power consumption in kilometers/miles per kilowatt, cabin climate control profiles, and driver speed, coasting, acceleration, and braking behaviors, as well as other vehicle data that is identical, similar, and/or otherwise suitable for global fleet grouping by the analytics engines of RFS(s).

Once such groupings of all global fleet vehicles is accomplished by RFS(s), then a particular vehicle or HEV 100 may also be peer matched, categorized, and/or grouped with at least one of such global fleet groups, such that RFS(s) can generate PMs 310 that identify a suitable global fleet group, to which the particular vehicle or HEV 100 belongs and/or is most closely matched according to VD 330. RFS(s) continuously receive, collect, ingest, and analyze VD 330 received in real-time from vehicles and HEVs 100, and continuously updates the contemplated groups according to patterns recognized in response to such analyses, such that RFS(s) can in real-time and upon demand generate the most accurate PMs 310 and group identifications of any particular BEV 100, according to the VD 330 from that vehicle or HEV 100.

In variations, RFS(s) also then generate DNs 300 according to PMs 310, to include recommendations included with RS 320 and obtained from global fleet groups identified by PMs 310, which are recognized by RFS(s) as identifying the most optimal fuel and battery performance characteristics of all global fleet vehicles in the group, such that one or more of fuel and/or battery consumption may be reduced for a particular operating HEV 100 or vehicle that is matched to the peer group.

In further modifications, RFS(s) generate TSs 315 and identify trip similarities and categories, and generate trip similarity scores and TSs 315 according to and by analyzing TD 335 received, collected, aggregated, and analyzed from all vehicles or HEVs 100 in the global fleet. Such TD 335 is utilized and analyzed by RFS(s) and includes for example, one or more of the estimated and/or predicted trip length or distance, predicted or planned or actual trip start and stop locations, frequency of trips having and/or similar to current trip parameters, and/or trip time or duration, and other related trip information.

RFS(s) analyze such TD 335 to generate TSs 315 that include a trip similarity score, which identifies and/or establishes how similar each trip of each vehicle or HEV 100 in the global fleet is to that of particular vehicles and HEVs 100. In this way, similar trips of all global fleet vehicles/HEVs 100 may also be grouped together for analytical, categorization, and/or grouping purposes to enable real-time and instantaneous RFS generation of TSs 315 according to received TD 335. Once such global fleet groupings are generated by RFS(s), then RFS(s) generate TSs 315 according to the TD 335, and RS 320 and TS 315 is communicated to the vehicle and HEV 100, the vehicle controller(s) generate(s) DNs 300 according to the received TSs 315 and RS 320, for each operating REV 100 and vehicle. The generated DNs 300 also incorporate recommendations included with RS 320 that are identified by RFS(s). The RFS(s) continuously identify global fleet vehicles/HEVs 100 that have the most optimal operating conditions according to the trip similarity categories and/or groupings. Consequently, fuel and/or battery consumption can be reduced by a particular operating vehicle or HEV 100, utilizing the DNs 300 generated according to the TSs 315 and RSs 320.

In further modifications, TSs 315 may include the trip similarity score, for purposes of additional illustration, to be a normalized score between zero and 100 or some other maximum value, which can be utilized to weight recommendations included with RS 320, such that DN 300 can also be further annotated to include data that alerts the driver and/or an autopilot or cruise control capability that a specific TS 315 is very similar and may be very beneficial if adopted during operation of vehicle and HEV 100, so as to reduce fuel and battery consumption.

Generation of an onboard determined and generated DN 300 by vehicle controller(s), which is generated according to and which utilizes offboard generated PM 310, TS 315, and RS 320 that are received from RFS(s), has been found to improve operating efficiency of vehicles and HEVs 100. Such a capability to utilize data aggregated and patterns recognized from a global fleet of vehicles is otherwise unavailable in view of the limited processing power and computing resources available onboard and in most vehicles and HEVs 100. Additionally, utilization of PM 310, TS 315, and RS 320, generated with the substantially greater resources of RFS(s), to adjust VPPs 305, reduces the consumption of the limited computational power and resources needed to accurately determine and adjust VPPs 305. Consequently, the cost to manufacture, maintain, and optimize the onboard processing and computational hardware and software resources for the vehicles and HEVs 100 can be reduced.

OCs 325 of HEV or vehicle 100 are periodically and/or at discrete time intervals generated by the various vehicle controllers, including for example one or more of VSC 200, VCS 205, PCU 215, TCU 220, MCM/BCM 185, ECU/EMS 225, and/or others. During operation, vehicle or HEV 100 may communicate OCs 325 when changes occur to various VPPs 305 and/or vehicle OCs 325, beyond various or predetermined thresholds and/or threshold values, and/or when changes occur at discrete predetermined periodic time intervals, such as for example every second or every few seconds or every few minutes, and/or at other preferred times and/or intervals as may be desired.

Upon receipt of PM 310, TS 315, and RS 320 from RFS(s) and generation by vehicle controller(s) of DNs 300, the controller(s) of vehicle 100 or REV 100 may be further configured to automatically adjust VPPs 305, by at least one of an autopilot or self-driving capability of HEV 100, RPCs, cruise control, or other automated vehicle capability. The adjusted VPPs 305 may also be adjusted such that speed and/or acceleration of vehicle or REV 100 is/are modified to responsively adjust and/or reduce one or more of fuel and/or battery consumption. The automatically adjusted VPPs 305 may include and/or enable automated adjustments to vehicle climate controls, cruise control, lighting, infotainment, navigation, and other HEV systems, subsystems, components, and/or devices.

In further variations, the vehicle controller(s) are configured to, respond to the RSs 320 and/or other signals and information received from RFS(s), and to also communicate DNs 300 audibly and/or textually, to one or more vehicle displays 190 and/or mobile device displays of NMDs 295, to enable a driver to adjust VPPs 305 and/or OCs 325, such as speed, acceleration, and/or braking, such that battery and/or fuel consumption of REV 100 may be reduced. In modifications of the disclosure, DNs 300 communicate recommended adjustments to speed, acceleration, braking, and/or other VPPs 305, and also may include and/or enable adjustments to vehicle climate controls, cruise control, lighting, infotainment, navigation, and other HEV systems, subsystems, components, and/or devices.

In further variations, the vehicle controller(s) are configured to, respond to the RSs 320 and/or other signals and information received from RFS(s), and to also communicate DNs 300 audibly, audiovisually, and/or textually, to one or more vehicle displays 190 and/or mobile device displays of NMDs 295, to enable a driver to adjust VPPs 305 and/or OCs 325, such as speed, acceleration, and/or braking, such that battery and/or fuel consumption of HEV 100 may be reduced. In modifications of the disclosure, DNs 300 communicate recommended adjustments to speed, acceleration, braking, and/or other VPPs 305, and also may include and/or enable adjustments to vehicle climate controls, cruise control, lighting, infotainment, navigation, and other REV systems, subsystems, components, and/or devices. The adjusted and/or adjustable VPPs 305, may include and/or enable automated adjustments to such controls, systems, subsystems, components, and/or devices.

The disclosure also contemplates RFSs configured to generate RS 320 to include at least one of and/or one or more of a fuel consumption estimate FCE 350 and a battery consumption estimate BCE 355. The various one or more vehicle controller(s) are further configured to detect VPPs 305 such as actual fuel and battery consumption, and to generate and/or store as an element of at least one of OSs 245, CSs 250, VPPs 305, and/or OCs 325, one or more estimate errors EEs 360. Such EEs 360 include and/or are each a respective difference between the FCE 350 and actual fuel consumption and BCE 355 and actual battery consumption. EEs 360 can be utilized by the vehicle controller(s) and/or RFS(s) as feedback to improve the accuracy of prospective FCEs 350 and/or BCEs 355.

In various configurations of operation, one of more of controller(s) VSC 200, VCS 205, and/or others of vehicle and HEV 100 are further adapted to change, modify, update, and/or readjust DNs 300 at discrete time intervals, and according to an updated RS 320, which is received by at least one of the communication units from RFs(s). In these arrangements, the updated RS 320 includes at least one updated FCE 350 and/or BCE 355, which is/are generated by and received from RFS(s). FCE 350 and/or BCE 355 are generated by RFS(s) in response to a new, real-time VPPs 305, OCs 325, and/or other vehicle signals. The new VPPs 305 and/or OCs 325 include or may include EEs 360, which RFS(s) utilize to analyze possible errors in prior generated FCEs 350 and/or BCEs 355, and to account for such feedback of any such past errors, when prospectively analyzing newly received VPPs 305 and OCs 325, such that RFS(s) can improve accuracy of prospectively generated FCEs 350 and BCEs 355.

The disclosure is also directed to implementations of vehicle and HEV 100 having one or more of the ATs and/or communication units USBs 275, NFCs 280, WRTs 285, CMTs 290, V2V 201, V2I/I2V 202, and/or other communication units, configured to communicate with the remote fleet server, by an authenticated connection to at least one mobile device, such as NMDs 295, located near, within, and/or proximate to a cabin of the vehicle or HEV 100. In this arrangement, the vehicle controller(s) are also configured to generate DNs 300, according to RSs 320, which include at least one and/or one or more recommendations to adjust at least one of vehicle VPPs 305, OCs 325 such as for example speed, braking, and acceleration. The vehicle controller(s) are also configured to communicate the generated DNs 300 to at least one and/or one or more of vehicle HMIs and displays 190 and/or NMDs 295.

The vehicle controller(s) may also be configured to enable offline operations when communications with RFS(s) may be interrupted or unavailable, and may capture, store, and enable retrieval to and from repository 230, of one or more of DNs 300, VPPs 305, PMs 310, TSs 315, RSs 320, OCs 325, VD 330, TD, 335, ERD 340, LOD 345, FCE 350, BCE 355, and/or EE 360, and other vehicle and RFS parameters, data, and information. Additionally, such stored data and parameters may be communicated to RFS(s) upon vehicle/HEV 100 re-establishing communications with RFS(s).

With continued reference to FIG. 1, and now also to FIG. 2, methods of operation of the disclosure include methods of controlling vehicle and HEV 100. In view of the components, controllers, systems, and capabilities already described, such methods contemplate enabling such methods by the controller(s) designated here generally as controller(s) 400, and which may include for purposes of illustration but not for purposes of limitation, at least one of and/or one or more of controller(s) VSC 200, VCS 205, PCU 215, TCU 220, MCM/BCM 185, and/or ECU/EMS 225, as well as communication unit(s) and transceivers AT, VSC 200, V2V 201, V2I/I2V 202, and/or VCS 205, among others. Such methods of operation start at step 405, and at step 410 include detecting TSG 255, which identifies initial and/or continuing vehicle operation and use.

At step 415, the method includes detecting changes in a time interval having elapsed and/or detecting changes in various VPPs 305, OCs 325, and/or other vehicle data and parameters, which causes at step 420 vehicle controller(s) 400 to detect, capture, generate, and communicate to RFS(s) and/or other vehicle or external devices, VPPs 305, OCs 325, VD 330, TD 335, ERD 340, LOD 345, EE 360, and/or other vehicle data, conditions, and parameters.

At step 425, in response to the detected TSG 255, and changed vehicle data and/or time intervals, the controller(s) 400 generate DN 300 according to PM 310, TS 315, and RS 320 received at step 430, to adjust one or more VPPs 305 and/or OCs 325, such that fuel and/or battery consumption can be adjusted and/or reduced according to the recommendations received with RS 320 from RFS(s) at step 430. Continuing at step 435, the vehicle controller(s) 400 monitor for and detect adjusted and/or changed vehicle data, including for example, VPPs 305, OCs 325, and other vehicle data. If such changes are detected, then at step 440, controller(s) 400 generate the estimate errors EE 360 by respectively comparing actual fuel and battery consumption to FCE 350 and BCE 355, which EEs 360 are communicated at step 445 to RFS(s) and other vehicle controller(s).

The methods continue at step 450, and control returns to start step 405 for continued monitoring and processing during the vehicle key-on condition and while TSG 255 is detected. While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle, comprising:
a controller coupled to a communication unit, and configured to, in response to a trip signal:
generate a driver notification to adjust one or more vehicle performance parameters,
according to peer match, trip similarity, and recommendation signals received from and generated by a remote fleet server,
responsive to instantaneous vehicle operating conditions communicated to the server; and
such that the adjusted parameters reduce one or more of fuel and battery consumption.

2. The vehicle according to claim 1, comprising:
the recommendation signal including at least one of a fuel and a battery consumption estimate; and
the controller further configured to, in response to detecting the one or more adjusted vehicle performance parameters:
generate and store as an element of at least one of the operating conditions and vehicle performance parameters, one or more estimate errors that are respective differences between the estimates and actual fuel and battery consumption.

3. The vehicle according to claim 2, comprising:
the controller further configured to, at discrete time intervals:
readjust the driver notification,
according to an updated recommendation signal, received by the communication unit from the remote fleet server, having at least one of an updated fuel and battery consumption estimate, and
in response to a new real-time operating condition, which includes the estimate errors, generated by the controller and communicated by the communication unit to the server.

4. The vehicle according to claim 1, comprising:
the communication unit configured to communicate with the remote fleet server, by an authenticated connection to a mobile device located proximate to a cabin of the vehicle; and
the controller further configured to:
generate the driver notification, according to the recommendation signal that includes one or more recommendations to adjust at least one of speed, braking, and acceleration vehicle performance parameters, and
communicate the generated driver notification to the mobile device.

5. The vehicle according to claim 1, comprising:
the controller further configured to:
generate the driver notification, according to the recommendation signal that includes one or more recommendations to adjust one or more of speed, acceleration, and braking vehicle performance parameters, and
communicate the generated driver notification to at least one of a vehicle display and a mobile device display.

6. The vehicle according to claim 1, comprising:
the communication unit configured to communicate with the remote fleet server, by an authenticated connection to a mobile device located proximate to a cabin of the vehicle; and
the controller further configured to:
generate the driver notification,
according to the recommendation signal that includes one or more recommendations to adjust at least one of braking, speed, and acceleration vehicle performance parameters, and at least one of an actual and estimated fuel and battery consumption, and
communicate the generated driver notification to at least one of a vehicle display and the mobile device.

7. The vehicle according to claim 1, comprising:
the communication unit configured to communicate with the remote fleet server, by an authenticated connection to a mobile device located proximate to a cabin of the vehicle; and
the controller further configured to:
generate the driver notification, according to the recommendation signal that includes one or more recommendations to adjust one or more of braking, speed, and acceleration vehicle performance parameters, and
communicate the generated driver notification to at least one of a vehicle display and the mobile device.

8. The vehicle according to claim 1, comprising:
the recommendation signal including at least one of a fuel and a battery consumption estimate; and
the controller further configured to, at discrete time intervals:
in response to detecting the one or more adjusted vehicle performance parameters:
generate and store as an element of at least one of the operating conditions and vehicle performance parameters, one or more estimate errors that are respective differences between the estimates and actual fuel and battery consumption,
readjust the driver notification,
according to an updated recommendation signal, received by the communication unit from the remote fleet server, having at least one of an updated fuel and battery consumption estimate, and
responsive to a new real-time operating condition including the estimate errors, generated by the controller and communicated to the remote fleet server.

9. The vehicle according to claim 1, comprising:
the controller further configured to generate the instantaneous vehicle operating conditions to include vehicle data having make and model information, and trip data having estimate length, frequency, and time;
the peer match signal generated according to the vehicle data;
the similarity signal generated according to the trip data; and
the recommendation signal generated by the remote fleet server according to the peer match and similarity signals.

10. The vehicle according to claim 1, comprising:
the controller further configured to generate the instantaneous operating conditions to include:
vehicle environment and location data that incorporates geographic location, ambient temperature, humidity, and atmospheric pressure,
vehicle data that incorporates vehicle identification number and onboard diagnostic codes and data, and
fuel and battery performance data that includes fuel and battery capacity, and battery chemistry, battery state of health and charge, battery temperature, and low voltage battery status.

11. A vehicle, comprising:
a controller coupled to a mobile device communication unit, and configured to, in response to a trip signal:
generate a driver notification to adjust one or more vehicle performance parameters,
according to a recommendation signal received from and generated by a remote fleet server,
responsive to instantaneous vehicle operating conditions communicated to the server; and
such that the adjusted parameters reduce one or more of fuel and battery consumption.

12. The vehicle according to claim 11, comprising:
the recommendation signal including at least one of a fuel and a battery consumption estimate; and
the controller further configured to, in response to detecting the one or more adjusted vehicle performance parameters:
generate and store as an element of at least one of the operating conditions and vehicle performance parameters, one or more estimate errors that are respective differences between the estimates and actual fuel and battery consumption.

13. The vehicle according to claim 12, comprising:
the controller further configured to, at discrete time intervals:
readjust the driver notification,
according to an updated recommendation signal, received by the communication unit from the remote fleet server, having at least one of an updated fuel and battery consumption estimate, and
in response to a new real-time operating condition, which includes the estimate errors, generated by the controller and communicated by the communication unit to the server.

14. The vehicle according to claim 11, comprising:
the controller further configured to:
generate the driver notification, according to the recommendation signal,
including one or more recommendations to adjust at least one of braking, speed, and acceleration vehicle performance parameters, and at least one of an actual and estimated fuel and battery consumption, and
communicate the generated driver notification to at least one of a vehicle display and the mobile device.

15. The vehicle according to claim 11, comprising:
the recommendation signal including at least one of a fuel and a battery consumption estimate; and
the controller further configured to, at discrete time intervals:
in response to detecting the one or more adjusted vehicle performance parameters:
generate and store as an element of at least one of the operating conditions and vehicle performance parameters, one or more estimate errors that are respective differences between the estimates and actual fuel and battery consumption,
readjust the driver notification,
according to an updated recommendation signal, received by the communication unit from the remote fleet server, having at least one of an updated fuel and battery consumption estimate, and
responsive to a new real-time operating condition including the estimate errors, generated by the controller and communicated to the remote fleet server.

16. A method of controlling a vehicle, comprising:
by a controller, coupled to a mobile device communication unit, responsive to a trip signal:
generating a driver notification to adjust one or more vehicle performance parameters,
according to a recommendation signal received from and generated by a remote fleet server,
responsive to instantaneous vehicle operating conditions communicated to the server; and
reducing, according to the adjusted parameters, one or more of fuel and battery consumption.

17. The method according to claim 16, further comprising:
the recommendation signal including at least one of a fuel and a battery consumption estimate; and
by the controller, responsive to detecting the one or more adjusted vehicle performance parameters:
generating and storing as an element of at least one of the operating conditions and vehicle performance parameters, one or more estimate errors that are respective differences between the estimates and actual fuel and battery consumption.

18. The method according to claim 17, further comprising:
by the controller, at discrete time intervals:
readjusting the driver notification,
according to an updated recommendation signal, received by the communication unit from the remote fleet server, having at least one of an updated fuel and battery consumption estimate, and
responsive to a new real-time operating condition, which includes the estimate errors, generated by the controller and communicated by the communication unit to the server.

19. The method according to claim 16, further comprising:
by the controller,
generating the driver notification, according to the recommendation signal,
including one or more recommendations to adjust one or more of braking, speed, and acceleration vehicle performance parameters, and at least one of an actual and estimated fuel and battery consumption, and
communicating the generated driver notification to at least one of a vehicle display and the mobile device.

20. The method according to claim 16, further comprising:
the recommendation signal including at least one of a fuel and a battery consumption estimate; and
by the controller, at discrete time intervals:
responsive to detecting the one or more adjusted vehicle performance parameters:
generating and storing as an element of at least one of the operating conditions and vehicle performance parameters, one or more estimate errors that are respective differences between the estimates and actual fuel and battery consumption,
readjusting the driver notification,
according to an updated recommendation signal, received by the communication unit from the remote fleet server, having at least one of an updated fuel and battery consumption estimate, and
responsive to a new real-time operating condition including the estimate errors, generated by the controller and communicated to the remote fleet server.
